(19) United States
(12) Patent Application Publication
(10) Pub. No.: US 2026/0220394 A1
(43) Pub. Date: Jul. 30, 2026

(54) MACHINE LEARNING MODEL-BASED CUSTOMIZED REAL-TIME SIGN LANGUAGE TRANSLATION

(71) Applicant: NVIDIA Corporation, Santa Clara, CA (US)

(72) Inventors: Ruthie D. Lyle, Durham, NC (US); Michael Ross Boone, Los Gatos, CA (US); Nikki Pope, Henderson, NV (US); David Lee Martin, Mountain View, CA (US)

(21) Appl. No.: 19/038,118

(22) Filed: Jan. 27, 2025

(51) Int. Cl. G06F 40/42; G06T 11/00

(52) U.S. Cl. CPC G06F 40/42; G06T 11/00

(57) ABSTRACT

In various examples, machine learning model-based customized real-time sign language translation is provided. A sign language translation framework may receive a data feed and detect when translation services are needed and a particular form of sign language is being used. The framework may translate incoming spoken language into a selected sign language to be used at the client application and generate video content to display the translated sign language content to the user interface of the client application. Sign language video data may comprise a representation of an animated avatar presented as an overlay performing signing corresponding to sign language translation data. The framework may generate an augmented video feed that modifies the appearance of a meeting participant to show the participant performing the sign language translation. A translation framework may conversely translate incoming video frames depicting users using sign language into spoken language data that may be audibly presented.

### BACKGROUND

Sign language translation represents a field of accessibility-focused technology for adapting digital platforms for better use by individuals with varying degrees of hearing difficulty. Sign language plays a crucial role in the lives of individuals who rely on it as their primary mode of communication. For these individuals, sign language is not just a tool for communication and expression but forms part of their identity and culture. However, the integration of sign language into technology presents unique challenges and opportunities. Deaf individuals, in particular, face a variety of challenges when it comes to technology accessibility. One of the main challenges is the lack of widespread support for sign language in digital platforms in order to engage with spoken word audio content and/or with other hearing individuals. This can lead to individuals experiencing a lack of independence and increased reliance on others for assistance, which in turn can lead to a sense of exclusion and frustration from the lack of ability to fully engage with others individuals or access multimedia content, using technology platforms.

### SUMMARY

Embodiments of the present disclosure relate to machine learning model-based customized real-time sign language translation. Systems and methods are disclosed that may provide real-time translation between spoken word and sign language, and/or between different sign languages.

In contrast to existing accessibility technologies for individuals with varying degrees of deafness, embodiments described herein provide for a neural network-based sign language translator that may translate between spoken word and sign language, as well as translate between different sign languages. A sign language translation framework implemented in a communication platform client application, and/or as a cloud computing platform service, may receive an incoming channel data feed and detect when translation services are needed. The sign language translation framework may determine when a client application is being used by a sign language signer (e.g., a user that natively communicates using sign language) and may determine the particular sign language being used by that user. In some embodiments, the sign language translation framework may read or otherwise obtain a sign language user preference indirectly. Additionally or alternatively, the sign language translation framework may determine the sign language user preference directly from the user, for example based on one or more interactions between the sign language translation framework and the sign language signer. The sign language translation framework may subsequently execute translations of an incoming channel data feed (e.g., data feed generated by another meeting participant) based on the sign language user preferences

For example, the sign language translation framework may detect the form (dialect) of sign language (e.g., JSL) from the input video feed, and execute translations of the incoming channel data feed(s) based on the preferred sign language (e.g., ASL) in real-time or near real-time. In some embodiments, the sign language translation framework may translate incoming spoken language data (e.g., audio and/or text data generated by other meeting participant(s) and received at the client application from the communication platform) into the preferred sign language to be used at the client application, and generate video content to display the translated sign language content to the user interface of the client application. The sign language translation framework may translate incoming sign language content data (e.g., video frames depicting other meeting participant(s) using a different sign language(s) that are received at the client application from the communication platform) into the preferred sign language, and generate video content to display at least the translated sign language content to the user interface of the client application. In some embodiments, the video content may comprise a representation of an animated avatar, and the user interface of the client application may present an overlay of the animated avatar that is generated based on the video content. The animated avatar may be generated by one or more machine learning models of the sign language translation framework to perform signing corresponding to the sign language translation data (e.g., preferred sign language) inferred from or otherwise associated with the outgoing channel data feed. In some embodiments, the sign language translation framework may generate an updated streaming video feed that augments (e.g., modifies) the appearance of a meeting participant to show the meeting participant performing the sign language translation. Moreover, in some embodiments, the sign language translation framework may operate in the converse direction to translate incoming sign language content data (e.g., video frames depicting other users using sign language) into spoken language data that may be audibly presented at the client applications of hearing meeting participants.

### BRIEF DESCRIPTION OF THE DRAWINGS

The present systems and methods for machine learning model-based customized real-time sign language translation are described in detail below with reference to the attached drawing figures, wherein:

FIG. 1 is a data flow diagram for an example process for a real-time sign language translation system, in accordance with some embodiments of the present disclosure;

FIG. 2 is a data flow diagram illustrating a sign language translation framework, in accordance with some embodiments of the present disclosure;

FIG. 3 is a data flow diagram illustrating example translation modes for a sign language translation framework, in accordance with some embodiments of the present disclosure;

FIG. 4 is a diagram illustrating an example user interface of a client application used in conjunction with a sign language translation framework, in accordance with some embodiments of the present disclosure;

FIG. 5 is a flow chart illustrating an example method for a real-time sign language translation system, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to machine learning model-based customized real-time sign language translation. Many technology platforms today provide communication channels through which groups of individuals can communicate with each other in order, for example, to collaborate on projects, exchange ideas and information, to facilitate social interaction, or for myriad other purposes. Examples of such platforms include teleconferencing platforms such as, but not limited to, Zoom, Cisco Webex, Microsoft Teams, Apple FaceTime, and the like. Human-machine interfaces implemented for such platforms typically include an audiovisual interface, where audio (e.g., voice) and image data are carried between meeting participants. The deaf community is one community that is, in particular, typically underserved by the human-machine interfaces (HMIs) provided by such platforms. Standard features of these HMIs may include real-time transcription and/or closed caption text that help an individual with deafness follow a spoken conversation, but the effectiveness of these technologies is often hampered by time delays and inaccuracies. American Sign Language (ASL) avatars have also been proposed that translate spoken word into ASL using an animated avatar that presents spoken content by signing. That said, these technologies still fall short in that they do not address the challenge of permitting the individual with deafness to use sign language to efficiently contribute to a real-time dialogue between participants. With that in mind, forms of sign language recognition based on convolutional neural network (CNN) models have been proposed. However, those technologies have been substantially directed at classification of fingerspelling images rather than generating a true translation of conversational sign language. Moreover, these technologies fall short of addressing multilingual scenarios. That is, while American Sign Language (ASL) is a prevailing form (dialect) of sign language used by individuals with deafness, British Sign Language (BSL), Spanish Sign Language (SSL), Japanese Sign Language (JSL), and French Sign Language (LSF), are examples of different sign languages having their own vocabularies and grammar rules. Technologies today do not provide fully accessible solutions that efficiently support the different possible permutations of the different sign languages that may be natively used by hearing-impaired users of those platforms.

In contrast to existing accessibility technologies for individuals with varying degrees of hearing difficulty, embodiments described herein provide for a neural network-based sign language translator that may translate between spoken word and sign language, as well as translate between different sign languages. For example, in some embodiments, a sign language translation framework implemented in a communication platform client application (and/or at least in part as a cloud computing platform service) may receive an incoming channel data feed (e.g., a video channel feed) and detect when translation services are needed. For example, the sign language translation framework may determine when a client application is being used by a sign language signer (e.g., a user that natively communicates using sign language) and may determine the particular sign language being used by that user. In some embodiments, the client application may include one or more user configurable preferences (settings) that indicate sign language user preferences elected by a user, such as whether the user of the client application indicates that they use sign language, and if so, may also include a sign language selection (preference).

The sign language translation framework may read the sign language user preference and execute translations of an incoming channel data feed based on the sign language user preference. In some embodiments, the sign language translation framework may determine sign language user preference directly from the user, for example based on one or more interactions between the sign language translation framework and the user.

For example, the sign language translation framework may evaluate an output video feed of the client application, where the user may register their sign language user preference with the sign language translation framework by signing in the sign language of their preference. The sign language translation framework may detect the form of sign language being used by the user (e.g., using a machine learning model trained to infer and classify sign languages), and use that determination to establish the sign language user preference of the user. The sign language translation framework may detect the form of sign language (e.g., JSL) from the input video feed, and execute translations of the incoming channel data feed based on the detected sign language user preference (e.g., ASL). In some embodiments, the sign language translation framework may translate incoming spoken language data (e.g., audio and/or text data generated by other meeting participant(s) and received at the client application from the communication platform) into the selected sign language to be used at the client application, and generate video content to display the translated sign language content to the user interface of the client application. That is, the sign language translation framework may detect the native language of the incoming spoken language data (e.g., English, German, Korean, etc.) that the user does not hear/understand and apply the spoken language data to one or more machine learning models to generate sign language translation data that corresponds to the selected sign language (e.g., ASL, BLS, SSL, JSL, LSF, or another form of sign language) that the user understands. The one or more machine learning models may then generate sign language video data based on the sign language translation data, and the sign language translation framework may present that sign language video data into a user interface of the client application used by the user. The sign language video data displayed by the user interface may comprise a dynamic (e.g., real-time animated) presentation of the sign language translation data (and thus a representation of the spoken word data received from the communication platform) presented in the form of sign language indicated by the sign language user preference.

In some embodiments, the sign language translation framework may translate incoming sign language content data (e.g., video frames depicting other meeting participant(s) using sign language(s) that are received at the client application from the communication platform) into the selected sign language, and generate video content to display the translated sign language content to the user interface of the client application. That is, the sign language translation framework may detect a native sign language appearing in an incoming feed of sign language data (e.g., ASL, BLS, SSL, JSL, LSF, or other sign language) using one or more machine language models. In some embodiments, when the native sign language appearing in incoming sign language content data is different than the user's selected sign language, the sign language translation framework may apply the incoming sign language content data to the one or more machine learning models to generate sign language translation data that corresponds to the selected sign language. The one or more machine language machine learning models may then generate sign language video data based on the sign language translation data, and the sign language translation framework may present that sign language video data into the user interface of the client application used by the user. As discussed above, the sign language video data displayed by the user interface may comprise a dynamic presentation of the sign language translation data (and thus a representation of the incoming sign language content data received from the communication platform) presented in the sign language versions indicated by the sign language user preference.

Although incoming sign language content data has been discussed herein as comprising video frames depicting signer using sign language, in some embodiments, incoming sign language content data may instead, or also, include iconic sign language symbols, such as but not limited to SignWriting and/or the International Sign Writing Alphabet (ISWA). SignWriting represents a sign language which utilizes symbols to represent hand movements, facial expressions, and spatial placement of signs. For example, iconic symbols for handshapes, orientation, body locations, facial expressions, contacts, and movement may be used to represent words in signed languages.

In some embodiments, the sign language video data may comprise a representation of an animated avatar, and the user interface of the client application may present an overlay of the animated avatar that is generated based on the sign language video data. The animated avatars may be generated by the one or more machine learning models of the sign language translation framework to perform signing corresponding to the sign language translation data inferred from the incoming channel data feed. In some embodiments, the user interface of the client application may present the animated avatar in a window of the user interface corresponding to a meeting participant whose spoken words and/or signing are associated with the translated incoming channel data feed. For example, the animated avatar may be overlaid onto a live streaming video feed included with the incoming channel data feed. That is, the sign language translation framework may modify the presentation of the live streaming video feed to include the animated avatar that is presenting the sign language translation. In some embodiments, the sign language translation framework may generate an updated streaming video feed that augments (e.g., modifies) the appearance of a meeting participant to show the meeting participant performing the sign language translation. That is, the sign language video data may comprise an augmented representation (e.g., an augmented reality version) of the original speaker/signer generated by the one or more machine learning models, where the original speaker/signer is presented as performing the signing corresponding to the sign language translation data inferred from the incoming channel data feed.

Moreover, in some embodiments, the sign language translation framework may operate in the converse direction to translate incoming sign language content data (e.g., video frames depicting other users using sign language that are received at the client application from the communication platform) into spoken language data that may be audibly presented at the client applications of hearing meeting participants. That is, in some embodiments, a hearing meeting participant may select a language user preference (e.g., in their respective client application) indicating that they elect to execute translation of an incoming channel data feed comprising sign language data into spoken language data in their selected language. In that case, a sign language translation framework may detect the native sign language appearing in incoming sign language content data (e.g., ASL, BLS, SSL, JSL, LSF, or other sign language) using the one or more models, and may apply the incoming sign language content data to the one or more machine language models to generate spoken word translation data (e.g., which may comprise a conversational translation and/or a word-for-word translation) that corresponds to the hearing meeting participant's selected spoken language. Based on the spoken word translation data, that participant's client application may present the spoken word translation data as text displayed on a user interface and/or as spoken audio generated by a generative artificial intelligence (AI) model.

As should be appreciated, a communication platform, such as a teleconferencing platform, may support virtual meetings that connect many individual meeting participants using respective client applications that each generate a channel data feed (e.g., audio and/or video feeds) that is distributed to the client applications of the other meeting participants. As such, each client application may receive a multitude of incoming feeds of channel data originating from the other meeting participants that are to be processed by a sign language translation framework to generate sign language translations as directed by indicated sign language user preferences elected by a user, and present those translations via the user interface (UI) of the client application to the user. In some embodiments, a sign language translation framework associated with a client application (when activated via sign language user preferences) may instantiate one or more translation processing paths, where each path provides the sign language translation with functionalities described herein for an individual feed of incoming channel data associated with a meeting participant. In some embodiments, individual sign language translation framework instances may be instantiated for a client application, where an individual sign language translation framework instance provides the sign language translation with functionalities described herein for an individual feed of incoming channel data associated with a meeting participant.

In some embodiments, a sign language translation framework as described herein may be implemented as a plugin or module component of the client application and executed locally on a client device. In some embodiments, the sign language translation framework may be implemented at least in part as a service (e.g., a microservice) exposed from a networked cloud computing platform. For example, in some embodiments, one or more functions of a sign language translation framework, such as one or more machine learning models providing one or more of sign language detection and/or translation functions, and/or generating sign language video data (e.g., avatars and/or modified video feeds), and/or generating spoken audio translations, may be accessed as services by the client application using, for example, application programming interface (API) function calls, HTTP control channels, and/or a WebRTC sender and receiver client for audio, video, and/or text data. In some embodiments, the sign language translation framework functionality may be implemented as a selectable service of the underlying communication platform (e.g., as an NVIDIA® Maxine-provided functionality) and implemented as network applications by one or more servers of the communication platform. In some embodiments, the sign language translation framework functionality may be distributed across the client applications, exposed network services, and/or network applications hosted by one or more servers. For example, a client application may comprise a front end of the sign language translation framework that communicates and interfaces with the user interface, and that communicates with a back end that comprises the computing hardware resources to execute the machine learning models of the sign language translation framework and generate translation data that is communicated back to the front end for presentation on the user interface.

In some embodiments, the one or more models of the sign language translation framework may be executed by a variety of different neural network architectures. For example, one or more models may comprise one or more encoder-decoder-based machine learning model architectures trained to perform sign language detection and translation functions, and/or one or more generative artificial intelligence models (e.g., small language model (SLM)-based models, large language model (LLM)-based models, video and/or audio generation models, etc.), an avatar manager (e.g., to instantiate and control an avatar), and/or models to generate augmented (modified) video. In some embodiments, the sign language translation framework may be implemented using an artificial intelligence (AI)-based software framework (e.g., a suite of cloud-hosted AI models) such as, but not limited to, NVIDIA's Tokkio.

In some embodiments, a sign language translation framework may comprise a first communication channel-processing path to receive and process incoming communication channel data from the communication platform. In some embodiments, the sign language translation framework may comprise a second communication channel-processing path to process and transmit incoming communication channel data for presentation to a client application. In some embodiments, the communication channel-processing paths may include an automatic speech recognition (ASR) software module that operates together with a dialogue manager (DM) software module and/or natural language processing artificial intelligence (AI). For example, the ASR may be implemented using NVIDIA's Riva. In some embodiments, the sign language translation framework may be implemented using a set of graphics processing unit (GPU)-accelerated multilingual speech and translation microservices that include speech-to-text and/or sign-language-to-speech neural machine translation services, and in some embodiments, may produce prompts used to interface with one or more LLM(s) accessible to the sign language translation framework.

In some embodiments, a sign language translation framework may be used in conjunction with other technology platforms. For example, in some embodiments, a sign language translation framework may be used to provide sign language accessibility to services provided through a kiosk user interface. For example, a kiosk may comprise a user interface through which hearing users may make requests and receive information through a spoken word dialogue with the user interface. That is, the user may provide spoken word queries and instructions as inputs to the kiosk, and receive spoken word answers or content in response. In some embodiments, such a platform may comprise a sign language translation framework that processes inputs and responses to provide sign language translations as discussed above. For example, when a user initiates interactions with the user interface, the sign language translation framework may receive a video data feed input that captures the user. Based on the video data feed input, the sign language translation framework may determine a sign language user preference by detecting whether the user is interacting with the user interface using sign language and/or which sign language version is being used. The sign language translation framework may translate the sign language data captured from the user into spoken language data that may then be processed by the kiosk, for example in the same manner that the kiosk would process spoken inputs from a user. Conversely, the sign language translation framework may input outgoing spoken word audio data produced by the kiosk into sign language translation data that corresponds to the user's detected sign language version. Based on the sign language translation data, the user interface may display an animated avatar that performs signing corresponding to the sign language translation data. As such, the user may perform their interactions with the kiosk user interface using their preferred sign language version, similar to how a user using a spoken word language would interact with the kiosk user interface.

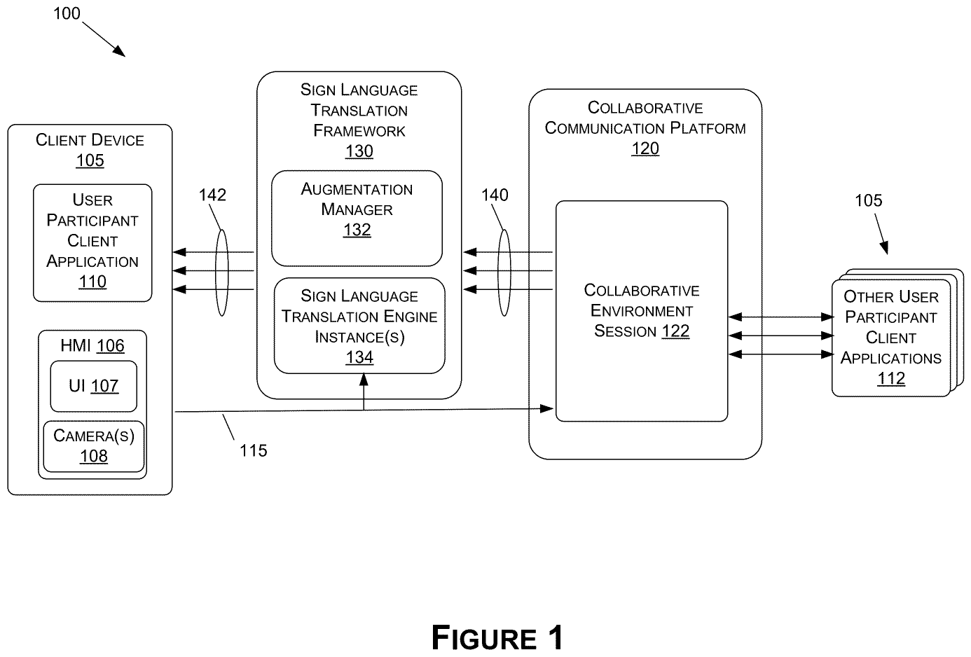

With reference to FIG. 1, FIG. 1 is an example data flow diagram for a process for a real-time sign language translation system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors comprising processing circuitry and executing instructions stored in memory.

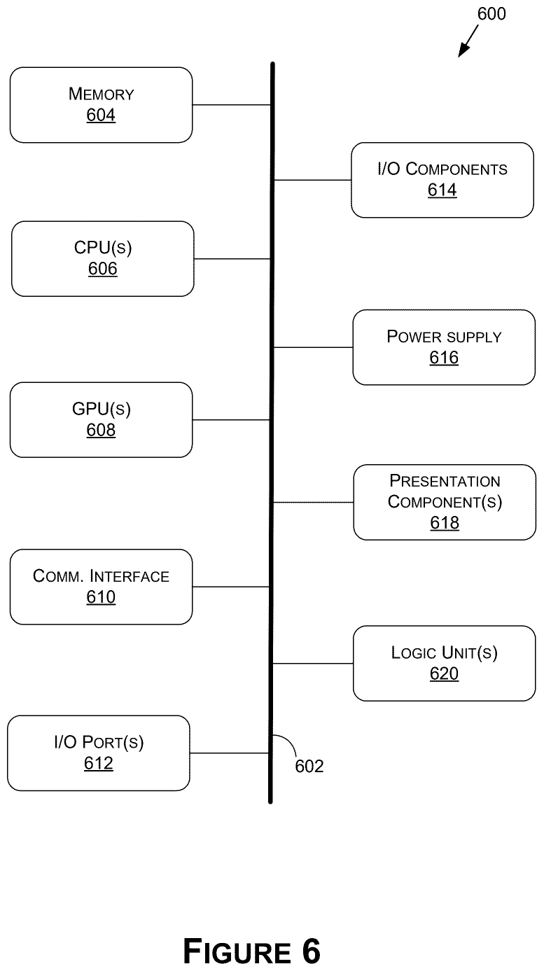

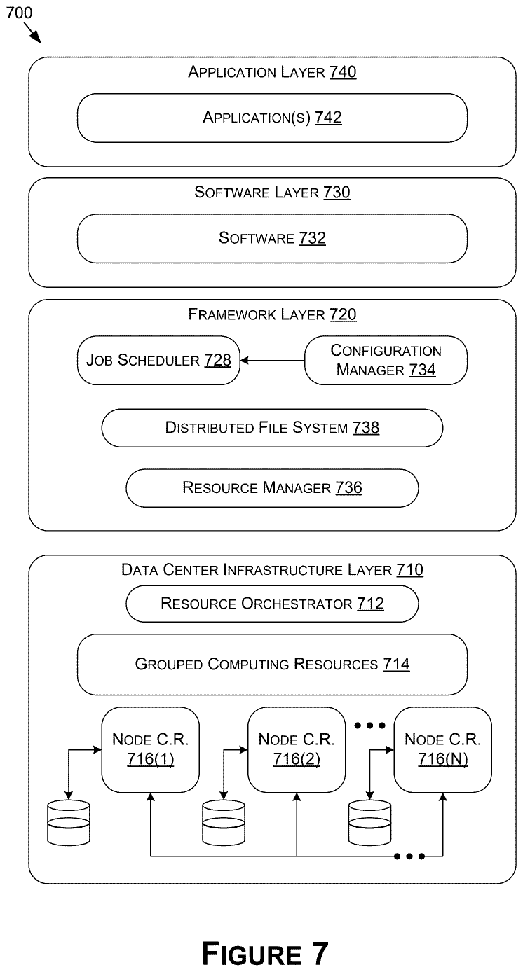

As shown in FIG. 1, the real-time sign language translation system 100 may comprise one or more client devices 105 that couple to a collaborative communication platform 120 to instantiate one or more virtual communications channels to exchange audio/visual content within the context of a collaborative environment session 122 (e.g., a virtual conference or meeting, a virtual environment, etc.) hosted by the collaborative communication platform 120. In some embodiments, one or more functions and/or components of the real-time sign language translation system 100 described herein may be realized at least in part using a computing device, such as computing device 600 shown in FIG. 6, and/or resources of a data center, such as data center 700 described with respect to FIG. 7. The collaborative communication platform 120 may comprise, as non-limiting examples, a conferencing service (e.g., Microsoft Teams, Zoom, Cisco Webex, GoToMeeting, and the like), a cloud-based collaborative content creation platform (e.g., NVIDIA Omniverse, or other multi-user virtual environments), and/or other platforms supporting real-time audio/video communications between user participants.

Generally, when the collaborative communication platform 120 initiates a conferencing meeting (e.g., a “call”), the collaborative communication platform 120 may establish an instance of the collaborative environment session 122. The collaborative environment session 122 defines a shared logical infrastructure established by the collaborative communication platform 120 that carries audio, video, text, and/or other forms of communications via a communication channel between a plurality of user participants who are attendees to the session 122. More specifically, a plurality of user participants (e.g., human users) may individually access the collaborative environment session 122 (e.g., via a networked connection) through their respective user participant client applications 110 and 112—which may be executed by the user participants using various client devices 105 (such as the computing device 600 shown in FIG. 6). The user participant client applications 110 and 112 may comprise, for example, a stand-alone video conferencing application (e.g., Microsoft Teams, Apple FaceTime, or other application) or a web browser application (e.g., Microsoft Edge) that accesses the collaborative environment session 122 via a web server (HTTP) protocol. As illustrated in FIG. 1, a client device 105 may comprise a human-machine interface (e.g., 106) through which a user may interact with the user participant client applications 110. For example, the HMI 106 may comprise one or more of a keyboard, pointing device, touchscreen, microphone, and/or other input interfaces for providing inputs to the user participant client application 110, and/or a display screen, speaker(s), and/or other output interfaces for providing content to the user from the user participant client application 110. In some embodiments, the device 105 and/or HMI 106 may comprise one or more cameras 108 that capture image data of the user for transmission to the collaborative environment session 122 as an uplink communications content data feed 115 (also referred herein as outgoing channel data feed). In some embodiments, the uplink communications content data feed 115 may comprise audio and/or video data captured from the user of user participant client application 110. As illustrated in FIG. 1, the HMI 106 may be controlled to display at least one user interface (UI) 107 generated by the user participant client application 110—which may display content received from other users of the collaborative environment session 122.

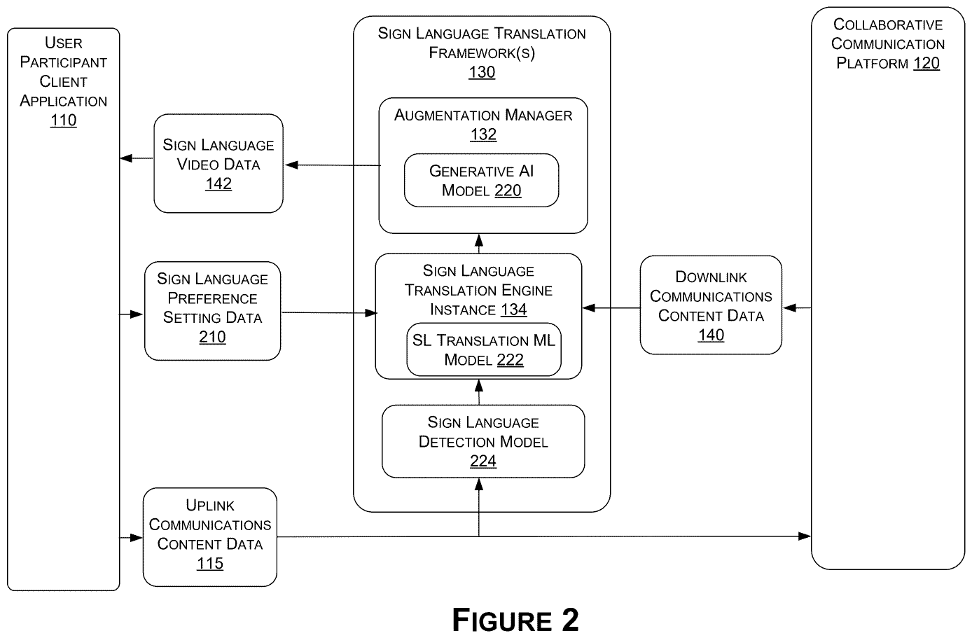

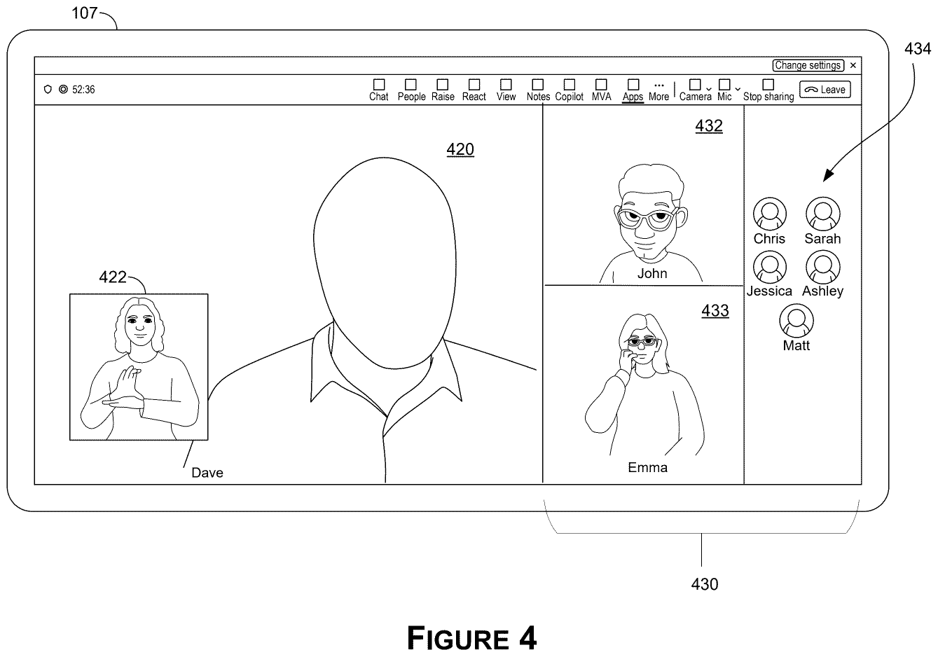

The real-time sign language translation system 100 may further include at least one sign language translation framework 130. As shown in FIG. 1, the sign language translation framework 130 may comprise a generative artificial intelligence-based augmentation manager 132 and may instantiate one or more machine learning model-based sign language translation engine instances 134. As described herein, the sign language translation framework 130 operates to receive downlink communication content data 140 (also referred herein as incoming channel data feed) comprising one or more feeds of content data (e.g., which may comprise voice, video, and/or data content). The downlink communication content data 140 may comprise, for example, content data generated by one or more of the other participants of the collaborative environment session 122 using the other user participant client applications 112, and distributed to meeting participants by the collaborative communication platform 120. As such, the downlink communication content data 140 may comprise a composite of individual downlink content data feed, where each individual downlink content data feed represents communication content generated by individual participants. As described herein, and in more detail with respect to FIG. 2, for each individual downlink content data feed, the sign language translation framework 130 may evaluate the individual communication content data feed from the composite downlink communication content data 140, and determine which (if any) trigger activation of sign language translation functions for that individual communication content data feed. In some embodiments, the sign language translation framework 130 may instantiate a respective sign language translation engine instance 134 for each individual communication content data feed for which sign language translation is activated—based on the incoming language mode of the incoming communication content data (e.g., whether a sign language or spoken language, and if so, which sign or spoken language) and a target language mode (e.g., whether a sign language or spoken language, and if so, which sign or spoken language) to be presented by the user participant client application 110 via the UI 107. For an individual communication content data feed, a respective sign language translation engine instance 134 for that feed may generate sign language translation data comprising a translation of the communications content data based at least on a sign language user preference obtained from the user participant client application 110. For example, where the user of user participant client application 110 has elected to use ASL, each instantiated sign language translation engine instance 134 will translate individual communication content data feed from the particular incoming language mode (whether a sign language or spoken language) into the selected sign language to produce a respective feed of downlink sign language translation data that is delivered to the augmentation manager 132. The augmentation manager 132 receives downlink sign language translation data from the one or more instantiated sign language translation engine instances 134, and for each feed of downlink sign language translation data, generates sign language video data representing a visual representation of the sign language translation data. The augmentation manager 132 may generate sign language video data that augments the individual communication content data feeds—for example by modifying an individual communication content data feed to include an animated avatar performing signing corresponding to the sign language translation data inferred from the incoming channel data feed. Such an animated avatar may be overlaid onto a live streaming video feed presented to the user by UI 107. In some embodiments, the augmentation manager 132 may generate sign language video data that modifies the appearance of a meeting participant to show the meeting participant performing the sign language translation in the target language mode. That is, the sign language video data may comprise an augmented representation (e.g., an augmented reality version) of the original speaker/signer comprising an updated video that modifies the appearance of the original speaker/signer, where the original speaker/signer is presented as performing the signing in the target language mode corresponding to the sign language translation data inferred from the incoming channel data feed. In some embodiments, where the target language mode is a spoken language (e.g., rather than a sign language), the augmentation manager 132 may generate audible spoken word data in the target language mode from the sign language translation data, where the audible spoken word data is emitted, for example, as an audible signal from a speaker of the HMI 106. In some embodiments, a composite of the sign language video data 142 produced by the augmentation manager 132 (e.g., the augmented video data and/or audible spoken word data) may be output from the sign language translation framework 130 and provided as downlink translated data feeds. The composite of the sign language video data 142 may comprise one or more individual feeds of sign language video data that are presented by the user participant client application 110 on UI 107 as video feeds associated with the other user participants (as discussed in more detail with respect to FIG. 4). Note that for an individual downlink communication content data feed that already has an incoming language mode determined as matching the target language mode of the receiving user, the sign language translation framework 130 may allow that communication content data feed to pass through the sign language translation framework 130 to the user participant client application 110 (e.g., along with composite sign language video data 142) without further processing.

Referring now to FIG. 2, FIG. 2 is an example data flow diagram illustrating a sign language translation framework 130, in accordance with some embodiments of the present disclosure. As discussed with respect to FIG. 1, the sign language translation framework 130 may process one or more streams (e.g., feeds) of downlink communications content data 140 from the collaborative communication platform 120 to produce one or more downlink translated data feeds of sign language video data 142 to the user participant client application 110 to control the UI 107 to display a visual representation of the sign language translation data.

As further illustrated in FIG. 2, the sign language translation framework 130 may instantiate one or more sign language translation engine instances 134 to translate downlink communications content data 140 into a target language mode. In some embodiments, the sign language translation framework 130 may instantiate dedicated sign language translation engine instances 134 for individual communication content data feeds to be translated to the target language mode. In some embodiments, a sign language translation engine instance 134 may be instantiated to process a plurality of individual communication content data feeds for translation to a target language mode.

As previously discussed, a target language mode for a sign language translation engine instance 134 may be determined based on information obtained from the user participant client application 110.

For example, in some embodiments, sign language translation engine instance 134 may input an indication of sign language preference setting data 210 received from the user participant client application 110 (e.g., as indicated in a user profile). For example, the user of user participant client application 110 may set a sign language user preference selecting a preferred sign language and/or selecting a preferred spoken language. The sign language translation engine instance 134 may input the sign language user preference and generate sign language translation data based on the indicated selections. For example, in some embodiments, the sign language preference setting data 210 may indicate a selection of a preferred sign language (e.g., ASL). In that case, the sign language translation framework 130 may instantiate the one or more sign language translation engine instances 134 with a target language mode configuration that translates downlink communications content data 140 into that selected preferred sign language (e.g., ASL). In other words, downlink communications content data 140 comprising spoken word data and/or sign language data based on a different sign language (e.g., BSL, LSF, or another non-ASL sign language) will be translated into content data presented in the preferred sign language. A preferred sign language may be determined from a variety of possible preferences by a user using the sign language translation framework 130 system at a particular the moment.

As another example, in some embodiments, a sign language translation engine instance 134 may infer the sign language user preference based on processing uplink communications content data 115 received from the user participant client application 110. For example, the sign language translation framework 130 comprises a sign language detection model 224 comprising a machine learning model trained to infer from video data when a sign language is being used and classify which sign language is being used. As such, the sign language translation framework 130 may detect that sign language translation services are needed based on evaluating the uplink communications content data 115 that the user participant client application 110 is transmitting to the collaborative communication platform 120. In some embodiment, the sign language translation framework 130 and/or sign language detection model 224 may infer a sign language preference based on various context available from the uplink communications content data 115, For example, the sign language translation framework 130 may use facial recognition, background noise, or other data to infer the sign language preference.

Based on the sign language detection model 224 determining when a sign language is being/to be used and which sign language is being used or preferred, the sign language translation framework 130 may instantiate the one or more sign language translation engine instances 134 with a target language mode configuration that translates downlink communication content data 140 into that preferred sign language (e.g., ASL). Downlink communications content data 140 comprising spoken word data and/or sign language data based on a different sign language (e.g., BSL, LSF, or another non-ASL sign language) will be translated into content data presented in the preferred sign language.

Also as previously discussed, in some embodiments a target language mode for a sign language translation engine instance 134 may be a spoken word language as opposed to a sign language. For example, in some embodiments, the indication of sign language preference setting data 210 received from the user participant client application 110 may indicate a particular spoken word language as the target language mode. For example, in some embodiments, the sign language preference setting data 210 may indicate a selection of a preferred spoken language (e.g., German). In that case, the sign language translation framework 130 may instantiate the one or more sign language translation engine instances 134 with a target language mode configuration that translates downlink communication content data 140 into that selected spoken word language (e.g., German). In other words, downlink communications content data 140 comprising sign language data will be translated into content data that may be audibly presented via the HMI 106 in the preferred spoken word language. In some embodiments, the sign language translation framework 130 may comprise a first communication channel-processing path comprising the one or more sign language translation engine instances 134 to process the downlink communications content data 140 received via the collaborative communication platform 120. In some embodiments, the sign language translation framework 130 may comprise a second communication channel-processing path comprising the augmentation manager 132 to produce sign language video data 142 for output to the user participant client application 110.

The one or more sign language translation engine instances 134 may be implemented using one or more sign language translation machine learning models 222 that may comprise one or more different neural network architectures. For example, a sign language translation engine instance 134 may be implemented using a sign language translation machine learning model 222 that comprises one or more encoder-decoder-based machine learning model architectures trained to perform sign language detection and translation functions and/or one or more generative artificial intelligence models (e.g., a small language model (SLM)-based model and/or an LLM-based model). A sign language translation engine instance 134 may include an automatic speech recognition (ASR) software module that operates together with a dialogue manager (DM) software module and/or natural language processing artificial intelligence (AI). For example, the ASR may be implemented using NVIDIA's Riva. In some embodiments, a sign language translation engine instance 134 may be implemented using a set of graphics processing unit (GPU)-accelerated multilingual speech and translation microservices that include speech-to-text and/or sign-language-to-speech neural machine translation services and in some embodiments, may produce prompts used to interface with one or more language models accessible to the sign language translation framework 130 and/or to the one or more sign language translation engine instances 134. Similarly, the augmentation manager 132 may be implemented using one or more sign language translation machine learning models 222 that may comprise one or more different neural network architectures. In some embodiments, the augmentation manager 132 may comprise one or more generative artificial intelligence models 220 (e.g., small language model (SLM)-based models, LLM-based models, video and/or audio generation models, and/or an avatar manager (e.g., to instantiate and control an avatar)) to generate the sign language video data 142. For example, in some embodiments, the generative artificial intelligence model(s) 220 may input as prompts the downlink sign language translation data from the one or more instantiated sign language translation engine instances 134, to generate the sign language video data 142 described herein. In some embodiments, the one or more models of the sign language translation framework 130 may be implemented at least in part using an artificial intelligence (AI)-based software framework (e.g., a suite of cloud-hosted AI models) such as, but not limited to, NVIDIA's Tokkio.

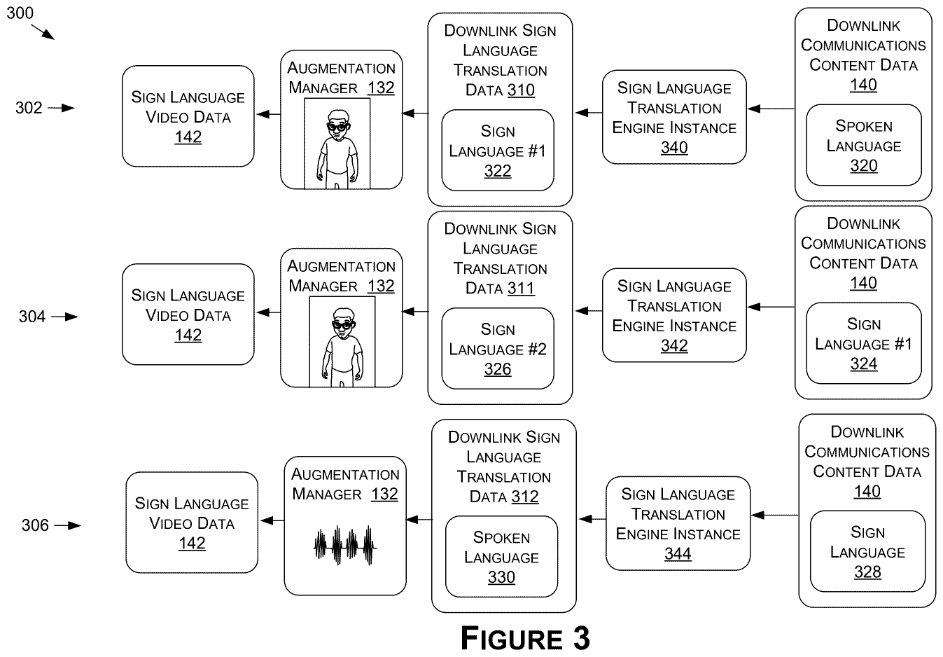

Referring now to FIG. 3, FIG. 3 is a data flow diagram 300 illustrating example translation modes for a sign language translation framework 130, in accordance with some embodiments of the present disclosure. That is, FIG. 3 illustrates example operations of language translation engine instances 134 translating downlink communication content data 140 from an incoming language mode to a target language mode.

As a first example at 302, a sign language translation engine instance 340 receives downlink communication content data 140 comprising spoken language data 320. Based on an obtained sign language user preference, the sign language translation framework 130 has determined that the target language mode is a first sign language 322 (e.g., ASL). Accordingly, the sign language translation engine instance 340 translates the spoken language data 320 into downlink sign language translation data 310 comprising the first sign language 322. The downlink sign language translation data 310 may be applied as a prompt to the augmentation manager 132, which generates augmentation content (e.g., an avatar overlay and/or an augmentation of the appearance of a meeting participant to show the meeting participant performing the sign language translation) as sign language video data 142 representing a visual representation of the sign language translation data.

As a second example at 304, a sign language translation engine instance 342 receives downlink communication content data 140 comprising first sign language data 324 (e.g., LSF). Based on an obtained sign language user preference, the sign language translation framework 130 has determined that the target language mode is a second sign language 326 (e.g., ASL). Accordingly, the sign language translation engine instance 340 translates the sign language data 324 into downlink sign language translation data 311 comprising the second sign language 326. The downlink sign language translation data 311 may be applied as a prompt to the augmentation manager 132, which generates augmentation content (e.g., an avatar overlay and/or an augmentation of the appearance of a meeting participant to show the meeting participant performing the sign language translation) as sign language video data 142 representing a visual representation of the sign language translation data.

As a third example at 306, a sign language translation engine instance 344 receives downlink communication content data 140 comprising sign language data 328 (e.g., LSF). Based on an obtained sign language user preference, the sign language translation framework 130 has determined that the target language mode is a spoken word language 330 (e.g., English). Accordingly, the sign language translation engine instance 340 translates the sign language data 328 into downlink sign language translation data 312 comprising the spoken word language 330. The downlink sign language translation data 312 may be applied as a prompt to the augmentation manager 132, which generates augmentation content comprising spoken word audio as sign language video data 142 representing an audible translation of the sign language translation data.

In some embodiments, a sign language translation framework 130 as described herein may be implemented as a plugin or module component of the client application 110 and executed locally on the client device 105. In some embodiments, one or more functions of the sign language translation framework 130 may be exposed to user participants of the collaborative environment session 122 as a cloud computing platform-based network service (e.g., a microservice). For example, in some embodiments, one or more functions of a sign language translation framework 130, such as one or more machine learning models of the sign language translation engine instance(s) 134, augmentation manager 132, and/or sign language detection model 224, may be accessed as services by the client application 110 using, for example, application programming interface (API) function calls, HTTP control channels, and/or a WebRTC sender and receiver client for audio, video, and/or text data. In some embodiments, the sign language translation framework 130 functionality may be implemented as a selectable service of the underlying communication platform 120 (e.g., as an NVIDIA® Maxine-provided functionality) and implemented as network applications by one or more servers of the communication platform 120. In some embodiments, the sign language translation framework 130 functionality may be distributed across the client applications, exposed network services, and/or network applications hosted by one or more servers. For example, a client application 110 may comprise a front end of the sign language translation framework 130 that communicates and interfaces with the user interface 107, and that communicates with a back end that comprises the computing hardware resources to execute the sign language translation engine instance(s) 134, augmentation manager 132, and/or sign language detection model 224.

Referring now to FIG. 4, FIG. 4 is a diagram illustrating an example user interface (UI) 107 generated by a user participant client application 110 representing a video conferencing session (e.g., a video conference call) associated with the collaborative environment session 122. In this example UI 107, the interface includes a primary presenter screen 420 presenting a video feed from the presenting user, and a participant region 430 that displays the other participants of the video conferencing session. As described herein, the collaborative environment session 122 includes the logical infrastructure established by the collaborative communication platform 120 to transport content data in real-time between the participants. As such, the UI 107 may be controlled to present the downlink communications content data 140 received from the other participants as individual content feeds. In this example, a number of the user participants have elected to share their real-time local video feeds so that those participants are presented in the participant region 430 as video using those real-time local video feeds, as shown by windows 432 and 433. Other user participants, represented at 434, have elected not to share real-time local video feeds and are instead presented in the participant's region 430 using still profile images or default images.

In some embodiments, the presenting user displayed in primary presenter screen 420 may be presenting content using a spoken word language. The content data displayed in primary presenter screen 420 may be based on sign language video data 142 generated by a sign language translation framework 130 from individual communication content data received from the client application 112 of that presenting user. In this example, the user participant client application 110 may have set a sign language user preference indicating a first sign language (e.g., ASL). As such, the sign language translation framework 130 produces an augmentation to the sign language video data 142 that produces an animated avatar 422 performing signing corresponding to the sign language translation data overlaid onto a live streaming video feed presented to the user by UI 107.

In this example, another participant shown at window 433 may also be generating content by speaking or signing. The content data displayed in window 433 may accordingly be based on sign language video data 142 generated by a sign language translation framework 130 from individual communication content data received from the client application 112 of that other user. In this example, the sign language translation framework 130 produces an augmentation to the sign language video data 142 in the form of an augmented representation (e.g., an augmented reality version) of the original speaker/signer comprising an updated video that modifies the appearance of the original speaker/signer, where the original speaker/signer is presented as performing the signing in the target language mode (e.g., ASL). Each window is described as including a single person, but it is possible for a window to include multiple people. In such cases, content generated in a window with multiple people may be augmented to modify the appearance of anyone speaking or signing in that window.

As previously mentioned, in some embodiments, the collaborative communication platform 120 may comprise a cloud-based collaborative content creation platform such as, but not limited to, NVIDIA Omniverse, or other augmented reality (AR)/virtual reality (VR)/mixed reality (MR) multi-user virtual environments. In some such embodiments, the sign language translation framework 130 may produce sign language video data used by the platform to render avatars within the virtual environment that may be signing using the sign language represented by the sign language video data. That is, a UI 107 may be implemented as an immersive AR/VR/MR rendering by an HMI 106 comprising AR/VR/MR goggles, glasses, or headset where each participant would see the avatar of the other participants with whom they are speaking and/or signing—where the individual renderings that the viewer experiences are presented as communicating in a sign language based on the viewer's sign language preferences.

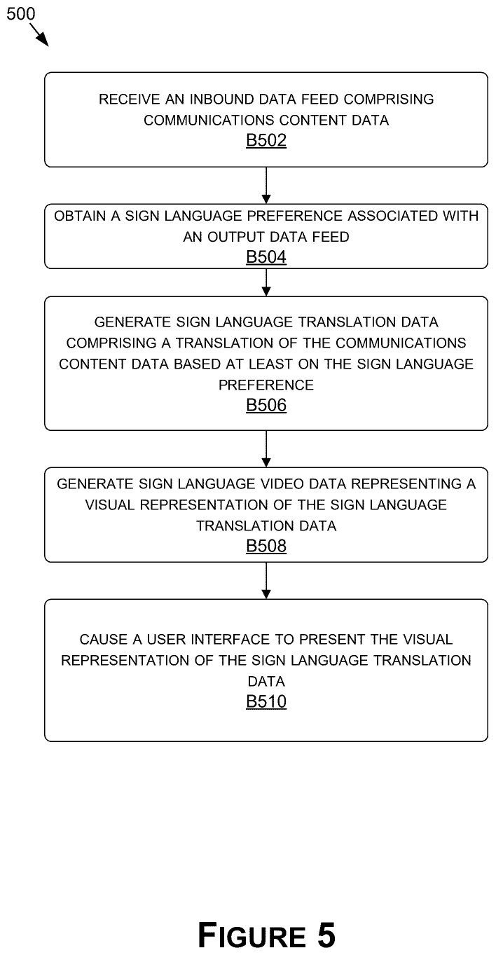

FIG. 5 is a diagram illustrating a method for a virtual participant service, in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa.

Each block of method 500, described herein, comprises a computing process that may be performed using any combination of hardware, firmware, and/or software. For instance, various functions may be carried out by one or more processors comprising processing circuitry and executing instructions stored in memory. The methods may also be embodied as computer-usable instructions stored on computer storage media. The methods may be provided by a standalone application, a service or hosted service (standalone or in combination with another hosted service), or a plugin to another product, to name a few. In addition, method 500 is described, by way of example, with respect to the virtual participant service system 100 of FIG. 1. However, these methods may additionally or alternatively be executed by any one system, or any combination of systems, including, but not limited to, those described herein.

As discussed herein in greater detail, the method may in general include generating sign language translation data comprising a translation of downlink content data based at least on a determination of a sign language preference associated with uplink content data, wherein the sign language preference indicates a form of sign language; and controlling a user interface to output a representation of the sign language translation data, wherein the representation of the sign language translation data comprises at least one of a visual representation of the sign language translation data or an audio representation of the sign language translation data.

generating sign language translation data comprising a translation of content data based at least on a determination of a sign language user preference, wherein the sign language user preference indicates a form of sign language; and controlling a user interface to output a representation of the sign language translation data, wherein the representation of the sign language translation data comprises at least one of a visual representation of the sign language translation data or an audio representation of the sign language translation data.

The method 500, at block B502, receiving an inbound data feed comprising communications content dat. The communications content data may comprise at least one of spoken word audio content data or incoming sign language content data. As described herein, the sign language translation framework 130 operates to receive a downlink communication content data 140 comprising a feed of content data (e.g., which may comprise voice, video, and/or data content). An individual feed from the downlink communication content data 140 may comprise, for example, content data generated by one or more of the other participants of the collaborative environment session 122 using the other user participant client applications 112, and distributed to meeting participants by the collaborative communication platform 120. As such, the downlink communication content data 140 may comprise a composite of individual downlink content data feed, where each individual downlink content data feed represents communication content generated by individual participants. As described herein, and in more detail with respect to FIG. 2, for each individual downlink content data feed, the sign language translation framework 130 may evaluate the individual communication content data feed from the composite downlink communication content data 140, and determine which (if any) trigger activation of sign language translation functions for that individual communication content data feed.

The method 500, at block B504, includes obtaining a sign language preference associated with an output data feed. For example, in some embodiments, sign language translation engine instance 134 may input an indication of sign language preference setting data 210 received from the user participant client application 110. For example, the user of user participant client application 110 (or other recipient of downlink communication content data 140) may set a sign language preference selecting a preferred sign language and/or selecting a preferred spoken language. The sign language translation engine instance 134 may input the sign language user preference and generate sign language translation data based on the indicated selections. As another example, in some embodiments, a sign language translation engine instance 134 may infer the sign language user preference based on processing uplink communications content data 115 received from the user participant client application 110. For example, the sign language translation framework 130 comprise a sign language detection model 224 comprising a machine learning model trained to infer from video data when a sign language is being used and classify which sign language is being used. As such, the sign language translation framework 130 may detect sign language translation services are needed based on evaluating the uplink communications content data 115 that the user participant client application 110 is transmitting to the collaborative communication platform 120.

The method 500, at block B506, includes generating sign language translation data comprising a translation of the communications content data based at least on the sign language preference. That is, the method may generate the sign language translation data based at least on a sign language determined based at least on the sign language user preference. In some embodiments, the method may obtain the sign language user preference based on reading a preference setting of a client application that generates the user interface. The method may obtain the sign language user preference based at least on a detection of a form of sign language from video data of a user of the user interface. In some embodiments, the determine the form of sign language based on applying the video data to one or more machine learning models to infer the form of sign language.

For an individual communication content data feed, a respective sign language translation engine instance 134 for that feed may generate sign language translation data comprising a translation of the communications content data based at least on a sign language user preference obtained from the user participant client application 110. For example, where the user of user participant client application 110 has elected to use ASL, each instantiated sign language translation engine instance 134 will translate individual communication content data feed from the particular incoming language mode (whether a sign language or spoken language) into the selected ASL to produce a respective feed of downlink sign language translation data that is delivered to the augmentation manager 132. In some embodiments, the method may execute a framework comprising one or more machine learning models that generate the sign language translation data based at least on the incoming channel data feed comprising the communications content data and a sign language version indicated by the sign language user preference. As an example, as discussed with respect to FIG. 2, the one or more sign language translation engine instances 134 may be implemented using one or more sign language translation machine learning models 222 that may comprise one or more different neural network architectures.

The method 500, at block B508, includes generating sign language video data representing a visual representation of the sign language translation data. The method may generate the sign language video data to comprise an animated avatar, wherein the animated avatar perform signing corresponding to the sign language translation data. The method may generate the sign language video data using a sign language version indicated by the sign language user preference, based at least on an augmentation of an appearance of a presenter of the communications content data. For example, as discussed herein, an augmentation manager 132 may receive downlink sign language translation data from the one or more instantiated sign language translation engine instances 134, and for each feed of downlink sign language translation data, generates sign language video data representing a visual representation of the sign language translation data. The augmentation manager 132 may generate sign language video data that augments the individual communication content data feeds. In some embodiments, a composite of the sign language video data 142 produced by the augmentation manager 132 (e.g., the augmented video data and/or audible spoken word data) may be output from the sign language translation framework 130 and provided as downlink translated data feeds. The composite of the sign language video data 142 may comprise one or more individual feeds of sign language video data that are presented by the user participant client application 110 on UI 107 as video feeds associated with the other user participants (as discussed in more detail with respect to FIG. 4).

In some embodiments, the method may execute a framework comprising one or more machine learning models that generate the sign language video data representing the visual representation of the sign language translation data based at least on the sign language translation data. As an example, as discussed with respect to FIG. 2, the augmentation manager 132 may comprise one or more generative artificial intelligence models 220 (e.g., small language model (SLM)-based models, LLM-based models, video and/or audio generation models, and/or an avatar manager (e.g., to instantiate and control an avatar)) to generate the sign language video data 142. For example, in some embodiments, the generative artificial intelligence model(s) 220 may input as prompts the downlink sign language translation data from the one or more instantiated sign language translation engine instances 134 to generate the sign language video data 142 described herein.

The method 500, at block B510, includes causing a user interface to present the visual representation of the sign language translation data. As illustrated in FIG. 1, the HMI 106 may be controlled to display at least one user interface (UI) 107 generated by the user participant client application 110—which may display content received from other users of the collaborative environment session 122. The augmentation manager 132 may generate sign language video data that augments the individual communication content data feeds—for example by modifying an individual communication content data feed to include an animated avatar performing signing corresponding to the sign language translation data inferred from the incoming channel data feed. Such an animated avatar may be overlaid onto a live streaming video feed presented to the user by UI 107. In some embodiments, the augmentation manager 132 may generate sign language video data that modifies the appearance of a meeting participant to show the meeting participant performing the sign language translation in the target language mode. That is, the sign language video data may comprise an augmented representation (e.g., an augmented reality version) of the original speaker/signer comprising an updated video that modifies the appearance of the original speaker/signer, where the original speaker/signer is presented as performing the signing in the target language mode corresponding to the sign language translation data inferred from the incoming channel data feed. In some embodiments, where the target language mode is a spoken language (e.g., rather than a sign language), the augmentation manager 132 may generate audible spoken word data in the target language mode from the sign language translation data, where the audible spoken word data is emitted, for example, as an audible signal from a speaker of the HMI 106.

In some embodiments, the method may control a multi-user virtual environment to render one or more avatars within the multi-user virtual environment to present the communications content data based at least on the sign language video data. As previously mentioned, the collaborative communication platform 120 may comprise a cloud-based collaborative content creation platform such as, but not limited to, NVIDIA Omniverse, or other augmented reality (AR)/virtual reality (VR)/mixed reality (MR) multi-user virtual environments. In some such embodiments, the sign language translation framework 130 may produce sign language video data used by the platform to render avatars within the virtual environment that may be signing using the sign language represented by the sign language video data. That is, a UI 107 may be implemented as an immersive AR/VR/MR rendering by an HMI 106 comprising AR/VR/MR goggles, glasses, or headsets where each participant would see the avatars of the other participants with whom they are speaking and/or signing—where the individual renderings that the viewer experiences are presented as communicating in a sign language based on the viewer's sign language preferences.

In some embodiments, the systems and methods described herein may be performed within, or in conjunction with, a simulation environment (e.g., NVIDIA's DRIVE SIM) using simulated data (e.g., simulated sensor data of simulated sensors of a virtual or simulated machine). For example, translated sign language data may be used to perform operations (e.g., navigating) associated with virtual machines and/or participants within the environment. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing a universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., central processing units (CPUs), graphics processing units (GPUs), hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models) and memory and/or storage (e.g., for storing entertainment content, navigation data, and user preferences). The system may use these processors to execute one or more machine learning models to enable features such as occupant monitoring, gesture recognition, and real-time communication with other services through network connectivity. The in-vehicle infotainment system may also use natural language processing (NLP) models to enable voice-based interaction and/or translated sign language-based interactions. The one or more machine learning models may be stored locally or accessed through one or more APIs that connect to cloud services, enabling the system to process requests in real-time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow the system to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers, etc.) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, vision language models (VLMs), LLMs, SLMs, multimodal language models (MMLMs), diffusion models, neural radiance field (NeRF) models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some examples, the machine learning model(s) (e.g., deep neural networks, language models, LLMs, SLMs, VLMs, multimodal language models (MMLM), perception models, tracking models, fusion models, transformer models, diffusion models, encoder-only models, decoder-only models, encoder-decoder models, generative adversarial networks (GANs), neural rendering field (NeRF) models, etc.) described herein may be packaged as one or more cloud-hosted microservices—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as representational state transfer (REST) APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a preconfigured container for simplified deployment, an optimized inference engine (e.g., built using a standardized AI model deployment and execution software, such as NVIDIA's Triton Inference Server, and/or one or more APIs for high-performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device and up to data-center scale). As such, the inference microservice may include the machine learning model(s) (e.g., that has been optimized for high-performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), and/or one or more vision language models (VLMs), small language models (SLMs), multi-modal language models (MMLMs), systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more functions of the user participant client application and/or sign language translation framework may be implemented by code executed by a computing device 600.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In some embodiments, one or more functions of the user participant client application and/or sign language translation framework may be implemented by code executed by one or more of CPU(s) 606, GPU(s) 608 and/or logic unit(s) 620.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, the HMI 106 displaying a UI 107 as described herein may be implemented using one or more presentation components 618.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740. In some embodiments, one or more functions of a sign language translation framework may be implemented at least in part using data center 700.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, one or more functions of a sign language translation framework as described herein may be implemented at least in part by code executed on one or more of node C.R.s 716(1)-7161(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In some embodiments, one or more functions of a sign language translation framework as described herein may be implemented at least in part by application(s) 742 and/or software 732.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
receive an inbound data feed comprising communications content data;
obtain a sign language preference associated with an output data feed;
generate sign language translation data comprising a translation of the communications content data based at least on the sign language preference;
generate sign language video data representing a visual representation of the sign language translation data; and
cause a user interface to present the visual representation of the sign language translation data.

2. The one or more processors of claim 1, wherein the communications content data comprises at least one of spoken word audio content data; text content data, video content data, or incoming sign language content data.

3. The one or more processors of claim 1, wherein the processing circuitry is further to control a multi-user virtual environment to render one or more avatars within the multi-user virtual environment to present the communications content data based at least on the sign language video data.

4. The one or more processors of claim 1, wherein the processing circuitry is further to generate the sign language translation data based at least on a sign language determined based at least on the sign language preference.

5. The one or more processors of claim 1, wherein the processing circuitry is further to obtain the sign language preference based on reading a preference setting of a client application that generates the user interface.

6. The one or more processors of claim 1, wherein the processing circuitry is further to obtain the sign language preference based at least on a detection of a form of sign language from video data of a user of the user interface.

7. The one or more processors of claim 6, wherein the processing circuitry is further to determine the form of sign language based on applying the video data to one or more machine learning models to infer the form of sign language.

8. The one or more processors of claim 1, wherein the processing circuitry is further to generate the sign language video data to comprises at least a portion of an animated avatar, wherein the at least the portion of the animated avatar performs signing corresponding to the sign language translation data.

9. The one or more processors of claim 1, wherein the processing circuitry is further to generate the sign language video data using a sign language version indicated by the sign language preference, based at least on an augmentation of an appearance of a presenter of the communications content data.

10. The one or more processors of claim 1, wherein the one or more processors are further to execute a framework comprising one or more machine learning models that generate the sign language translation data based at least on the communications content data and a sign language indicated by the sign language preference.

11. The one or more processors of claim 1, wherein the one or more processors are further to execute a framework comprising one or more machine learning models that generate the sign language video data representing the visual representation of the sign language translation data based at least on the sign language translation data.

12. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system for generating or presenting virtual reality (VR) content;
a system for generating or presenting augmented reality (AR) content;
a system for generating or presenting mixed reality (MR) content;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multimodal language models (MMLMs);
a system implemented using one or more cloud-hosted microservices;
a system for generating synthetic data;
a system for generating synthetic data using AI;
a system incorporating one or more virtual machines (VMs);
a system implemented at least partially in a data center; or
a system implemented at least partially using cloud computing resources.

13. A system comprising one or more processors to:
receive a first data feed comprising communications content data;
obtain a sign language preference associated with a second data feed;
generate sign language translation data comprising a translation of the communications content data based at least on a language indicated by the sign language preference; and
cause a user interface to output an augmented representation of the first data feed based on the sign language translation data.

14. The system of claim 13, the one or more processors further to generate a visual representation of the sign language translation data, wherein the representation of the sign language translation data comprises the visual representation of the sign language translation data.

15. The system of claim 14, the one or more processors further to generate the visual representation of the sign language translation data to comprise at least a portion of an animated avatar, wherein the portion of the animated avatar performs signing corresponding to the sign language translation data using a sign language version indicated by the sign language preference.

16. The system of claim 14, wherein the one or more processors are further to generate the visual representation of the sign language translation data based at least on an augmentation of an appearance of a presenter of the communications content data as represented by the first data feed.

17. The system of claim 13, the one or more processors further to generate an audio representation of the sign language translation data, wherein the representation of the sign language translation data comprises the audio representation of the sign language translation data.

18. The system of claim 13, the one or more processors further to execute a framework comprising one or more machine learning models that generate the sign language translation data based at least on the first data feed comprising the communications content data and a sign language version indicated by the sign language preference.

19. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system for generating or presenting virtual reality (VR) content;
a system for generating or presenting augmented reality (AR) content;
a system for generating or presenting mixed reality (MR) content;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multimodal language models (MMLMs);
a system implemented using one or more cloud-hosted microservices;
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
generating sign language translation data comprising a translation of downlink content data based at least on a determination of a sign language preference associated with uplink content data, wherein the sign language preference indicates a form of sign language; and
controlling a user interface to output a representation of the sign language translation data, wherein the representation of the sign language translation data comprises at least one of a visual representation of the sign language translation data or an audio representation of the sign language translation data.
